(19) United States
(12) Patent Application Publication
(10) Pub. No.: US 2014/0028437 A1
(43) Pub. Date: Jan. 30, 2014

(54) AUTOMATICALLY APPLYING GEOGRAPHICAL CONSTRAINTS ON ELECTRONIC DEVICE FUNCTIONALITY: METHOD AND APPARATUS

(71) Applicants: Mahmood Majid, Lakeville, MN (US); Newton Guillen, Minnetonka, MN (US)

(72) Inventors: Mahmood Majid, Lakeville, MN (US); Newton Guillen, Minnetonka, MN (US)

(73) Assignee: BBY SOLUTIONS, INC., Richfield, MN (US)

(21) Appl. No.: 13/558,382

(22) Filed: Jul. 26, 2012

(51) Int. Cl. G06F 7/00

(52) U.S. Cl. 340/5.1

(57) ABSTRACT

The present invention is a system and process for adjusting the performance of an electronic device based upon geographical location. For example, government regulations, applicable to a specific state or country, might limit energy usage by some device. The process involves accessing the location, accessing relevant constraints for that location and device, and taking appropriate actions if necessary. If the device were a television or monitor, a postal code might be entered during set-up or other configuration, possibly by a remote control operated through a user interface. Conversion from location and device type to required actions might be executed by logic on the device itself, or a remote location. The device might keep current with changes to regulations by receiving updates across a communication system such as the Internet.

### FIELD OF THE INVENTION

The present invention relates to geographical constraints on electronic devices. More specifically, it relates to automatically applying geographical constraints to an electronic device.

### BACKGROUND OF THE INVENTION

Geographical constraints on electronic devices, for example constraints on energy usage, often arise from regulation. Countries and states may differ in the types of applicable constraints, and on specific limiting quantitative values. A given constraint may apply to devices having specific functional features, such as television or monitor screens, or to more general classes of devices.

### SUMMARY OF THE INVENTION

Locally-applicable government might constrain total energy usage of a device or a class of devices, which for a monitor, might in turn constrain screen brightness or other operating features. The source of such law might be, for example, a statute, regulation, judicial decision, executive decision, or edict. Without loss of generality, we will refer to such a law as a “regulation.” Different jurisdictions or political divisions—e.g., countries, states, provinces, counties, or cities may vary in how strictly some device functionality is constrained by regulation, and whether they regulate the particular type of usage at all.

Consider, for example, constraints on energy consumption, applicable to all new television monitors. A manufacturer could simply configure all its new monitor models to satisfy the very most stringent constraint of all political divisions where it plans to market its monitors. This worst-case approach shortcomings, such as: (1) users in a jurisdiction with more lenient laws will have to tolerate restricted performance quality; (2) what constitutes the most stringent constraint may change by action of any of the jurisdictions; (3) a distributor might sell the product in a jurisdiction that was not contemplated by the manufacturer; and (4) a user may move to a jurisdiction where the TV is noncompliant.

By determining where the device is being operated, the quality of its performance may be optimized within all locally-applicable constraints on energy usage. Logic may be applied to (1) determine the geographical location of the device; (2) determine any applicable regulations; (3) determine how compliance will be achieved; and (4) control the device so as to comply with the regulations.

By “logic” we mean hardware logic and/or software instructions accessed from storage that are executed by processing hardware. By “storage” we mean memory, optical disk, hard disk, solid state disk, flash memory, or any other tangible storage device or medium capable of holding information in digital form.

The logic described above might be built into the device itself, executed at some remote location, or split between the device and one or more other location. Essentially, logic in the device must carry out the step of controlling the device to comply with the regulations, and must be provided with enough information or instructions to do so.

In some countries, such as the United States and Canada, a postal code might be used to determine location of the device. A user might be asked to enter the postal code as part of a process of initially configuring the device. In the case of a TV or computer, asking the user a number of questions is typical of initial set-up. Such information might be entered wirelessly through a remote control, but other approaches are possible. For example, a keyboard, a mouse, and/or a touch screen might be used, in lieu of or in addition to a remote control. The postal code might be saved in storage as part of this process. Reconfiguration or modifications of the current configuration, including changes to the stored location, might be enabled; such a feature might be used if the device is moved to another location.

Geographic location might be determined in other ways. The location of the device might be determined using satellites through, for example, a geographical positioning system (GPS). If the device has wireless telephone capability, the position might be determined by triangulation using cell phone towers. Other methods of determining location are also possible.

The applicable regulations may be saved in storage. Logic may determine which legal constraints on energy consumption are applicable to a particular geographical location. Regulations might be saved by geographical location in the form of constraints, with values for ranges on parameters. For example, in jurisdiction A, the value of some parameter B for a device of type C must be in the range D to E; or not exceed D. In some jurisdictions, zip code or postal code where the device is located might suffice to specify jurisdiction. Regulations might be saved by device (category of device, size, configuration, brand, model, product ID, and/or serial number).

It is useful to regard a constraint as either general or device-specific. A general constraint, applicable in some jurisdiction, might require that energy usage by all new consumer electronic devices be less than a particular value. A general constraint usually states the regulation itself. In order to achieve that regulation, a manufacturer may need to constrain one or more functionalities of a particular model of a particular type of device. Such specific constraints may vary among manufacturers, device types, and models of a given device type.

Constraints might be saved in the general form. Each model may then contains logic to look up the constraints, and convert those constraints, based upon location, into behavior(s) for the particular model device. Different models might comply with a general constraint by modifying different aspects of functionality. An advantage of this approach is that a table of general constraints might be maintained by some organization—which might be the manufacturer, a governmental body, or a third-party business—that keeps track of changes to all such applicable regulations from all jurisdictions as they evolve.

On the other hand, logic can be simplified or eliminated by directly storing, for a particular model, how various functionalities will be adjusted to achieve compliance with a given general constraint. A third approach (actually, a particular instance of using logic to convert general constraints into particular model behavior) would be to store general constraints, and mappings from various ranges of general constraints into model-specific actions or limits, in databases.

Constraints may be stored in one location or in a plurality of locations. Such locations may include the device itself, or facilities remote from the device but accessible through a communication system. By communication system, we mean a system for wired or wireless communication, using any protocol or combination of protocols, over any type of hardware or combination of hardware components. A bus, wide-area network, local-area network are just a few examples. Two connected communication systems form another communication system.

A remote facility would be particularly useful for maintaining a database of all applicable general constraints. A table on the device itself might, for example, specify particular modifications to functionality that are required to achieve various levels of some general constraint.

A remote facility, by communication with the device through some communication system, might provide the capability for modifying or replacing the table in the device to keep an internal table, used by the device logic to constrain device functionality, current.

In another approach, a manufacturer maintains at a site, remote from the device, a table keyed by model and geographical location. The table includes specific instructions or settings (e.g., dim the screen by this amount) for how this model should behave, such that the behavior will satisfy general constraints that form the basis for the instructions or settings. The device communicates the geographic location over a communication system to the manufacturer, and receives the instructions. The device might automatically poll the site from time to time for updates, or the site might automatically notify the television when updates are necessary. In some configurations, there might be no provision for updates. In some configurations, such a table might be stored in the electronic device itself, not requiring communication with a remote site.

After the appropriate actions required for this device in this location have been determined, logic in the device causes the device to take appropriate action(s). These actions may be time dependent. For example, a screen might be required to dim after a certain period. The actions may be contextual. For example, the television might be required to sense ambient light, and adjust brightness accordingly—a brighter screen only for brighter ambient conditions.

Note too that, within the scope of the invention, other constraints or dependencies may exploit a known geographical location, either alone or in combination with energy-based restrictions. Such constraints might apply to such factors as, for example, privacy and security regulations; sound output; parental controls; language; tuner (e.g., analog or digital TV); communication frequency bands; and services available from application providers. The invention encompasses constraints on any type of electronic device including, for example, televisions, monitors, audio players/recorders, video players/recorders, and cell phones.

### BRIEF DESCRIPTION OF THE DRAWINGS

FIG. 1 is a flowchart of a system automatically applying geographical constraints on energy usage.

FIG. 2 is a schematic drawing of a system automatically applying geographical constraints on energy usage.

### DETAILED DESCRIPTION OF EXEMPLARY EMBODIMENTS

This description provides embodiments of the invention intended as exemplary applications. The reader of ordinary skill in the art will realize that the invention has broader scope than the particular examples described here.

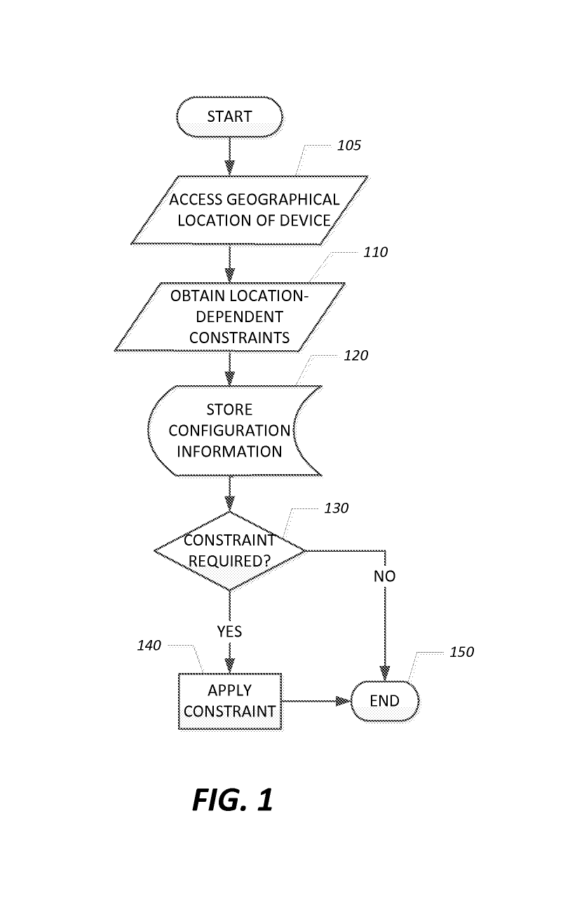

FIG. 1 is a flowchart of an exemplary system automatically applying geographical constraints on energy usage. Note that the steps might be executed in a different order. Some steps might be omitted. Other steps might be added, such as steps suggested by discussion elsewhere in this document for various embodiments. In some embodiments, as mentioned in the Summary above, constraints may apply to types of device functionality that are not oriented toward energy usage.

Parameters relevant to energy are accessed 105. These parameters might include postal code, or other indicator of geographical location. Various techniques for determining geographical location have already been discussed herein. Parameters might also include data regarding the device itself, including, for example, brand, model, serial number, and/or size. A parameter might be entered by a user, such as a postal code entered through a remote control 230 or other user interface. A parameter might be accessed from storage on the device, or received from a communication system. A parameter might be hard-coded in software instructions, or implicit within hardware.

Based on the parameters, energy constraints are accessed 110. These energy constraints might be in any number of forms, but will depend on geographical location. They might be some form of government regulations; for example, energy consumption for a type of device may not exceed a certain amount. They might be in the form of a device-specific table, such that if the location is X, then a lookup performed by logic specifies particular action(s) the device must take. The constraints might be located in storage on the device itself, or remotely. Depending on how the constraints initially specified, conversion into actionable items might be required. Logic to perform such conversion, and storage in which software and data are held, might be located remotely, on the device, or some combination thereof.

In this embodiment, some information about the energy configuration—the parameters, the constraints, or the actionable items—is stored 120. Again, such storage may be on the device, a remote system, or some combination of them.

In some instances, a process like that described so far may not require any action (e.g., dimming a screen) whatsoever for this particular device. In this case, the process ends 150. If action is required, then the relevant action is taken 140.

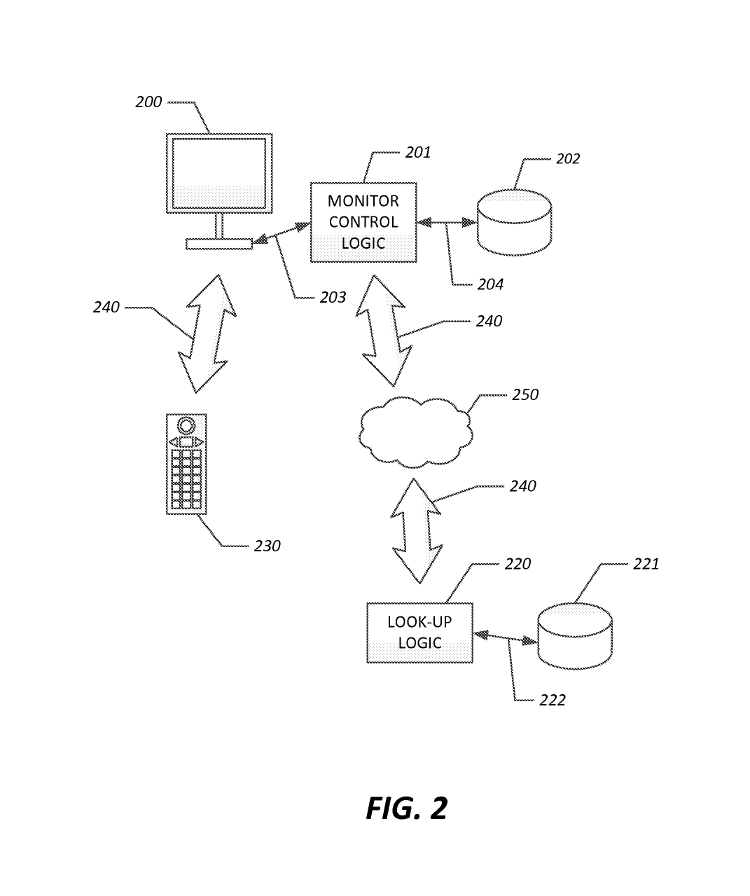

FIG. 2 is a schematic drawing of an illustrative system automatically applying geographical constraints on energy usage. Interaction among components in this drawing might correspond to the process depicted in FIG. 1. Data might be entered by a user through any form of user interface, such as the remote control 230 depicted in the figure. Here, the remote control 230 communicates wirelessly with a monitor 200. A monitor 200 or television is a type of device that might use the process of FIG. 1, but of course there are many other kinds of electronic devices that consume energy and hence come within the conceptual scope.

The monitor 200 includes monitor-control logic 201 that controls its functionality, as indicated by arrow 203. The monitor-control logic 201 may access arrow 204 (read from or write to) storage 202 within the device itself. Depending upon embodiment, this storage 202 might include software instructions that, in conjunction with processing hardware, convert the geographical location into specified actions of the device, such as energy-saving actions. The storage might contain a table used in such conversion. It might include parameters about the device itself, such as product make, model, serial number, or physical characteristics. It might include a table of actions that might be taken, depending upon constraints and parameters. It might include an indicator of the geographic location itself. In general, any data relevant to geographically-dependent actions of the device might be stored by monitor-control logic 201 on the storage 202.

In some embodiments, interpretation of a geographical location as one or more energy-saving actions might be entirely self-contained within the electronic device itself. In the embodiment shown, however, the monitor-control logic 201 interacts with a remote site, where look-up logic 220 uses arrow 222 the storage 221 device to perform part or all of the interpretation or conversion. Using this approach, the information may be kept up-to-date as regulation changes in various jurisdictions, and less information and simpler logic may be required for individual devices.

Communication between the remote control 230 and the monitor 200, and between the monitor-control logic 201 and the look-up logic 220 may use various communication systems 240. Although redundant, since a communication system 240 by our definition might include any form of digital network, FIG. 2 shows a cloud to emphasize that a wide-area network 250 such as the Internet might be involved.

Of course, many variations of the above method are possible within the scope of the invention. The present invention is, therefore, not limited to all the above details, as modifications and variations may be made without departing from the intent or scope of the invention. Consequently, the invention should be limited only by the following claims and equivalent constructions.

What is claimed is:

1. A method, comprising:
a) accessing geographical location of an electronic device; and
b) determining whether a location-dependent constraint on an aspect of usage of the device applies to the geographical location.

2. The method of claim 1, wherein the electronic device is a television, a monitor, an audio player, an audio recorder, a video player, or a video recorder.

3. The method of claim 1, further comprising:
c) receiving an indicator of the geographic location through a user interface.

4. The method of claim 3, wherein the user interface includes a remote control.

5. The method of claim 3, wherein the indicator is a postal code or zip code.

6. The method of claim 1, wherein the constraint is based upon a law.

7. The method of claim 1, further comprising:
c) constraining a function of the device according to the constraint.

8. The method of claim 7, wherein the function is setting screen brightness.

9. The method of claim 7, wherein the constraint relates to a parental control.

10. The method of claim 1, wherein location dependence is based upon jurisdictional boundaries.

11. The method of claim 1, further comprising:
c) transmitting an indicator of the geographical location to a communication system that includes a wide-area network; and
d) receiving the location-dependent constraint from the communication system.

12. The method of claim 1, further comprising:
c) transmitting an indicator of the geographical location to a communication system that includes a wide-area network, wherein information used in the determining step is received from the communication system.

13. The method of claim 1, further comprising:
c) accessing the location-dependent constraint from tangible storage on the electronic device.

14. A method, comprising:
a) receiving an indicator of geographical location of an electronic device from a communication system that includes a wide-area network;
b) determining whether a location-dependent constraint on a function of the device applies to the geographical location; and
c) transmitting information to the communication system regarding the constraint.

15. An apparatus, comprising:
a) an electronic device;
b) logic that
(i) accesses geographical location of an electronic device; and
(ii) determines whether a location-dependent constraint on a function of the device applies to the geographical location.

16. The apparatus of claim 15, further comprising:
c) a remote control from which the logic receives an indicator of geographical location.

17. The apparatus of claim 15, wherein the logic also
(iii) constrains a function of the apparatus if the location-dependent constraint applies.

18. The apparatus of claim 15, wherein the function is setting screen brightness.

19. The apparatus of claim 15, wherein the function is setting screen brightness.

20. The apparatus of claim 15, wherein the constraint relates to a parental control.
